(19) United States
(12) Patent Application Publication
(10) Pub. No.: US 2014/0157146 A1
(43) Pub. Date: Jun. 5, 2014

(54) METHOD FOR RETRIEVING FILE AND ELECTRONIC DEVICE THEREOF

(71) Applicant: Samsung Electronics Co., Ltd., Suwon-si (KR)

(72) Inventor: Sang-Min SHIN, Osan-si (KR)

(73) Assignee: Samsung Electronics Co., Ltd., Suwon-si (KR)

(21) Appl. No.: 14/096,663

(22) Filed: Dec. 4, 2013

(30) Foreign Application Priority Data
Dec. 4, 2012 (KR) 10-2012-0139538

(51) Int. Cl. G06F 3/0482; G06F 3/0481

(52) U.S. Cl. CPC G06F 3/0482; G06F 3/04817
USPC 715/748

(57) ABSTRACT

A method for retrieving a file and an electronic device thereof are provided. The method includes a menu selection for retrieving a file is detected. Upon the menu selection being detected, a file retrieve window including at least one icon one-to-one mapped to a most recently operated file is displayed.

### CROSS-REFERENCE TO RELATED APPLICATION(S)

This application claims the benefit under 35 U.S.C. §119(a) of a Korean patent application filed on Dec. 4, 2012 in the Korean Intellectual Property Office and assigned Serial No. 10-2012-0139538, the entire disclosure of which is hereby incorporated by reference.

### TECHNICAL FIELD

The present disclosure relates to an electronic device. More particularly, the present disclosure relates to a method and an apparatus for retrieving a file in an electronic device.

### BACKGROUND

Recently, as a technology develops, an electronic device provides various functions. For example, the electronic device provides functions such as an alarm, a Short Messaging Service (SMS), a Multimedia Message Service (MMS), an electronic (e)-mail, games, communication, an image management function, a multimedia function providing audio and video contents, and a schedule function.

As the function of the electronic device is diversified, kinds and the number of files stored in the electronic device increase rapidly. As the file of the electronic device is diversified and the number of files increases, a user should recognize an accurate position of a file in order to retrieve the file. For example, in the case where a user selects a first file among a plurality of files stored in an electronic device and desires to attach the file to all applications such as an e-mail and a messenger that allow the user to transmit the file to a specific person, the user should recognize a path of a position where the file is stored in advance. Also, even though the user recognizes the path of the stored position of the first file in advance, the user has an inconvenience of having to select a folder corresponding to the relevant stored position one by one and enter the stored position.

As described above, in the case where the user retrieves a specific file and desires to attach or load the file, the user has an inconvenience of having to recognize the stored position of all files and enter the stored position of a relevant file every time whenever the user attaches or loads the file. Accordingly, there is a need for a method for easily retrieving a file in an electronic device under a circumstance where a user cannot accurately recognize the stored position of the file or a circumstance where the stored position of the file is complicated.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for selecting a file in an electronic device.

Another aspect of the present disclosure is to provide a method and an apparatus for selecting a most recently accessed file in an electronic device.

Still another aspect of the present disclosure is to provide a method and an apparatus for selecting a most recently stored file in an electronic device.

Yet another aspect of the present disclosure is to provide a method and an apparatus for displaying a file retrieve window including an icon one-to-one mapped to a most recently operated file in an electronic device.

In accordance with an aspect of the present disclosure, a method for retrieving a file in an electronic device is provided. The method includes detecting menu selection for retrieving a file, and upon the detecting of the menu selection, displaying a file retrieve window including at least one icon one-to-one mapped to a most recently operated file.

In accordance with another aspect of the present disclosure, an electronic device for retrieving a file is provided. The electronic device includes one or more processors, an Input/Output (I/O) unit, a memory, and one or more programs stored in the memory and configured for execution by the one or more processors, wherein the one or more programs include an instruction for detecting menu selection for retrieving a file, and upon the detecting of the menu selection, for displaying a file retrieve window including at least one icon one-to-one mapped to a most recently operated file.

Other aspects, advantages and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain various embodiments of the present disclosure will be more apparent from the following description taken in conjunction with the accompanying drawings, in which:

FIG. 1A is a block diagram illustrating an electronic device for displaying an icon mapped to a most recently operated file on a file retrieve window according to an embodiment of the present disclosure;

FIG. 1B is a block diagram illustrating a processor for displaying an icon mapped to a most recently operated file on a file retrieve window according to an embodiment of the present disclosure;

FIG. 2A is a flowchart illustrating a procedure for displaying an icon mapped to a most recently operated file on a file retrieve window in an electronic device according to an embodiment of the present disclosure;

FIG. 2B is a view illustrating means for displaying an icon mapped to a most recently operated file on a file retrieve window in an electronic device according to an embodiment of the present disclosure;

FIG. 3 is a flowchart illustrating a procedure for displaying an icon mapped to a most recently operated file on a file retrieve window in an electronic device according to an embodiment of the present disclosure;

FIG. 4 is a view illustrating an example of displaying an icon mapped to a most recently operated file on a file retrieve window in an electronic device according to another embodiment of the present disclosure; and

FIG. 5 is a view illustrating an example of displaying a quick menu window for a folder in an adjacent region of the folder in an electronic device according to an embodiment of the present disclosure.

Throughout the drawings, like reference numerals will be understood to refer to like parts, components and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the present disclosure are provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the description below, an electronic device includes a mobile communication terminal, a smart phone, a tablet Personal Computer (PC), a digital camera, a digital audio player, a navigation, a laptop, a netbook, a computer, a television, a refrigerator, and an air conditioner that store at least one file.

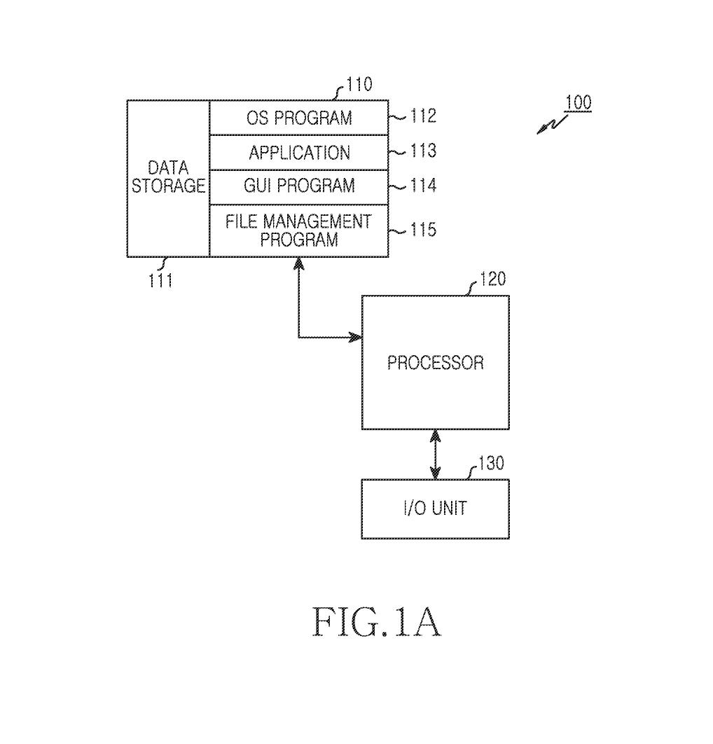

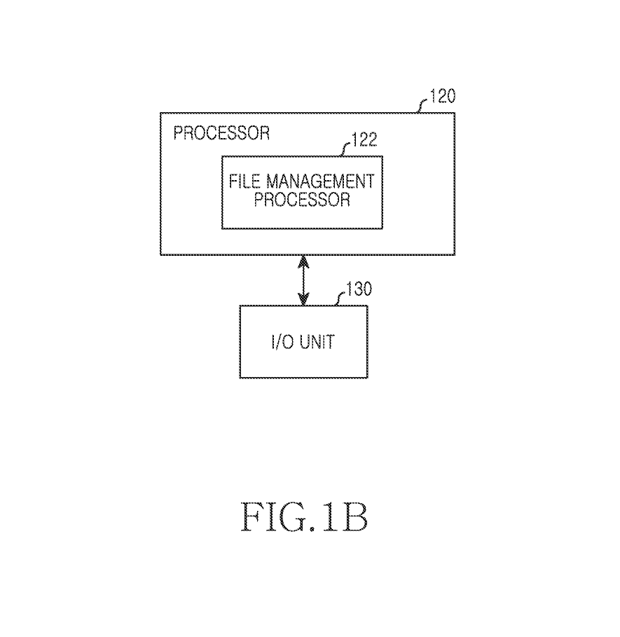

FIG. 1A is a block diagram illustrating an electronic device 100 for displaying an icon mapped to a most recently operated file on a file retrieve window according to an embodiment of the present disclosure.

Referring to FIG. 1A, the electronic device 100 includes a memory 110, a processor 120, and an Input/Output (I/O) unit 130. A plurality of memories 110 and processors 120 may exist.

The memory 110 includes a data storage 111, an Operating System (OS) program 112, an application 113, a Graphic User Interface (GUI) program 114, and a file management program 115. Also, since a program which is a software element may be expressed as a set of instructions, the program may be expressed as an instruction set. The program may be also expressed as a module.

The memory 110 may store one or more programs including instructions performing an embodiment of the present disclosure.

The data storage 111 stores data generated while a function corresponding to a program stored in the memory 110 is performed. The data storage 111 according to the present disclosure stores at least one file generated by a user or downloaded from another device or a server. Here, the file denotes all types of files that may be stored in the electronic device. For example, the file may be a document file, a moving picture file, an image file, a music file, and a game file.

Particularly, the data storage 111 may store information for a most recently accessed file. For example, the data storage 111 may store path information for a most recently accessed first file and the stored position of the first file. At this point, the data storage 111 may update and store information of the most recently accessed file whenever a user accesses the file. For example, in the case where the user accesses a second file when the user stores information of the first file as most recently accessed file information, the data storage 111 may change the most recently accessed file information from information of the first file to information of the second file, and store the same.

In addition, the data storage 111 may store information for a most recently stored file in the electronic device 100. For example, the data storage 111 may store a first file most recently received from another electronic device and path information of the stored position of the first file as information for the most recently stored file. For another example, the data storage 111 may store a second file most recently received from a server and path information of the stored position of the second file as information for the most recently stored file. For still another example, the data storage 111 may store a first file whose contents have been modified and then stored and path information of the stored position of the first file as information for the most recently stored file.

The OS program 112 (for example, WINDOWS, LINUX, Darwin, RTXC, UNIX, OS X, or a built-in OS like VxWorks) includes various software elements for controlling a general system operation. For example, control of the general system operation denotes memory management and control, storage hardware (device) control and management, power control and management, etc. The OS program 112 performs a function for swift communication between various hardware (devices) and software elements.

The application 113 includes applications such as a browser application, an e-mail application, a messaging application, a word processing application, an address book application, a widget application, a Digital Right Management (DRM) application, a voice recognition application, a voice duplication application, a position determining function application, a location based service application, a telephone application, etc.

The GUI program 114 includes at least one software element for providing a user interface between a user and the electronic device 100 using graphics. That is, the GUI program 114 includes at least one software element for displaying user interface information on the I/O unit 130. According to the present disclosure, the GUI program 114 includes an instruction for displaying an icon one-to-one mapped to a most recently accessed file and/or an icon one-to-one mapped to a most recently stored file on a file retrieve window. At this point, the icon one-to-one mapped to the most recently accessed file and/or the most recently stored file may be displayed on an arbitrary region of the file retrieve window.

The file management program 115 maps a most recently accessed file to a specific icon. In detail, the file management program 115 determines the most recently accessed file and one-to-one maps the determined file to a specific icon. For example, in the case where a first moving picture file has been executed most recently, the file management program 115 may one-to-one map the first moving picture file to a specific icon. For another example, in the case where a first music file has been executed most recently, the file management program 115 may one-to-one map the first music file to a specific icon. At this point, whenever the most recently accessed file is updated, the file management program 115 updates the file mapped to the icon using the updated file.

In addition, in the case of detecting selection of a specific icon mapped to a most recently accessed file among icons displayed on a file retrieve window of a specific program, the file management program 115 selects the most recently accessed file mapped to the relevant icon. For example, in the case where menu selection for file attachment is detected in a document editor, the file management program 115 may display a file retrieve window including a plurality of icons. In the case where selection of a specific icon mapped to a most recently accessed document file among the plurality of icons is detected, the file management program 115 may attach the most recently accessed file to the document editor. For another example, in the case where menu selection for a load file is detected in a moving picture reproducer, the file management program 115 may display a file retrieve window including a plurality of icons. In the case where selection of a specific icon mapped to a most recently accessed file among the plurality of icons is detected, the file management program 115 may load the most recently accessed moving picture file and reproduce the same.

Also, the file management program 115 maps a most recently stored file to a specific icon. In detail, the file management program 115 determines the most recently stored file and one-to-one maps the determined file to a specific icon. At this point, the most recently stored file may be a file stored from another electronic device or a server or a file updated and stored. For example, in the case where a first image file is downloaded from another electronic device, the file management program 115 may one-to-one map the first image file to a specific icon. For another example, in the case where a first music file is received from a server and stored, the file management program 115 may one-to-one map the first music file to a specific icon. For still another example, in the case where a first document file stored in the memory is updated, the file management program 115 may one-to-one map the first document file to a specific icon.

In addition, in the case where selection for a specific icon mapped to a most recently stored file among icons displayed on a file retrieve window is detected, the file management program 115 selects the most recently stored file mapped to the specific icon. For example, in the case where menu selection for file attachment is detected in an e-mail editor, the file management program 115 may display a file retrieve window including a plurality of icons. In the case where selection of a specific icon mapped to a most recently stored file among the plurality of icons is detected, the file management program 115 may attach a most recently stored image file mapped to the specific icon to an e-mail. For another example, in the case where menu selection for file load is selected in a document editor, the file management program 115 may display a file retrieve window including a plurality of icons. In the case where selection of a specific icon mapped to a most recently stored file is detected among the plurality of icons, the file management program 115 may load the most recently stored document file mapped to the specific icon.

Though not shown, the processor 120 may include at least one processor and a peripheral interface. Also, the processor 120 executes a specific program (e.g., instruction set) stored in the memory 110 to perform a plurality of specific functions corresponding to the program.

The I/O unit 130 includes an input unit that may input data and an output unit that may output data to provide an interface to a user. For example, the I/O unit 130 may be a touchscreen that may input/output data simultaneously. The I/O unit 130 according to the present disclosure may display an icon mapped to a most recently accessed file and/or an icon mapped to a most recently stored file on a file retrieve window. At this point, the displayed icon may be an icon having the same layout as those of other icons displayed on the file retrieve window. In addition, the I/O unit 130 may display an icon mapped to a most recently accessed file and/or an icon mapped to a most recently stored file on a tool box for quick execution. For example, in a case of a moving picture reproduction player, the I/O unit 130 may display an icon mapped to a most recently accessed moving picture file and/or an icon mapped to a most recently stored moving picture file on a tool box window including menus related to moving picture reproduction. For another example, in case of a document editor, the I/O unit 130 may display an icon mapped to a most recently accessed document file and/or an icon mapped to a most recently stored document file on a tool box including menus related to document writing and editing.

FIG. 1B is a block diagram illustrating a processor for displaying an icon mapped to a most recently operated file on a file retrieve window according to an embodiment of the present disclosure.

Referring to FIG. 1B, the processor 120 may include a file management processor 122.

The file management processor 122 maps a most recently accessed file to a specific icon. Specifically, the file management processor 122 determines a most recently accessed file and one-to-one maps the determined file to a specific icon. For example, in the case where a first moving picture file is most recently executed, the file management processor 122 may one-to-one map the first moving picture file to a specific icon. For another example, in the case where a first music file is most recently executed, the file management processor 122 may one-to-one map the first music file to a specific icon. At this point, whenever the most recently accessed file is updated, the file management processor 122 changes the file mapped to the icon to the updated file.

In addition, in the case where selection of a specific icon mapped to a most recently accessed file is detected among icons displayed on a file retrieve window of a specific program, the file management processor 122 selects the most recently accessed file mapped to the relevant icon. For example, in the case where menu selection for file attachment is detected in a document editor, the file management processor 122 may display a file retrieve window including a plurality of icons. In the case where selection of a specific icon mapped to a most recently accessed document file is detected among the plurality of icons, the file management processor 122 may attach the most recently accessed file mapped to the specific icon to the document editor. For another example, in the case where menu selection for file load is detected in a moving picture reproducer, the file management processor 122 may display a file retrieve window including a plurality of icons. In the case where selection of a specific icon mapped to a most recently accessed file is detected among the plurality of icons, the file management processor 122 may load and reproduce the most recently accessed moving picture file mapped to the specific icon.

Also, the file management processor 122 maps a most recently stored file to a specific icon. In detail, the file management processor 122 determines a most recently stored file and one-to-one maps the determined file to a specific icon. At this point, the most recently stored file may be a file stored from another electronic device or a server, or a file updated and stored. For example, in the case where a first image file is downloaded from another electronic device, the file management processor 122 may one-to-one map the first image file to a specific icon. For another example, in the case where a first music file is received and stored from a server, the file management processor 122 may one-to-one map the first music file to a specific icon. For still another example, in the case where a first document file stored in the memory is updated, the file management processor 122 may one-to-one map the first document file to a specific icon.

In addition, in the case where selection of a specific icon mapped to a most recently stored file is detected among icons displayed on a file retrieve window, the file management processor 122 selects the most recently stored file mapped to the specific icon. For example, in the case where menu selection for file attachment is detected in an e-mail editor, the file management processor 122 may display a file retrieve window including a plurality of icons. In the case where selection of a specific icon mapped to a most recently stored file is detected among the plurality of icons, the file management processor 122 may attach a most recently stored image file mapped to the specific icon to an e-mail. For another example, in the case where menu selection for file load is detected in a document editor, the file management processor 122 may display a file retrieve window including a plurality of icons. In the case where selection of a specific icon mapped to a most recently stored file is detected among the plurality of icons, the file management processor 122 may load the most recently stored document file mapped to the specific icon.

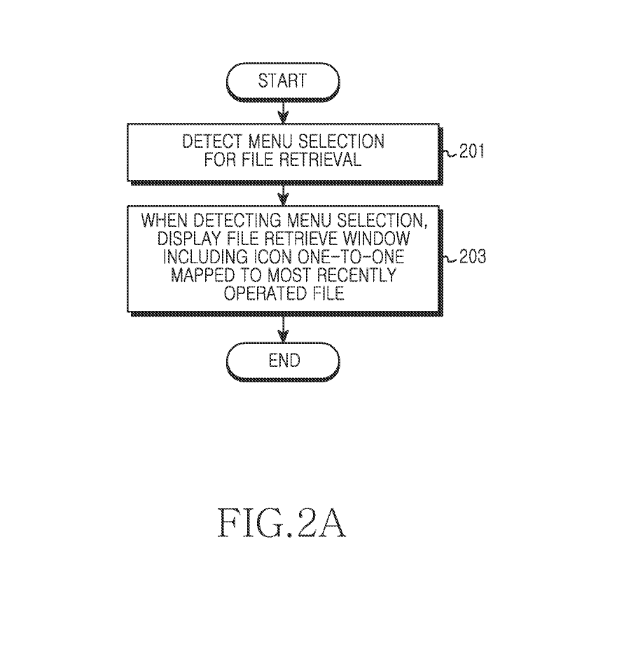

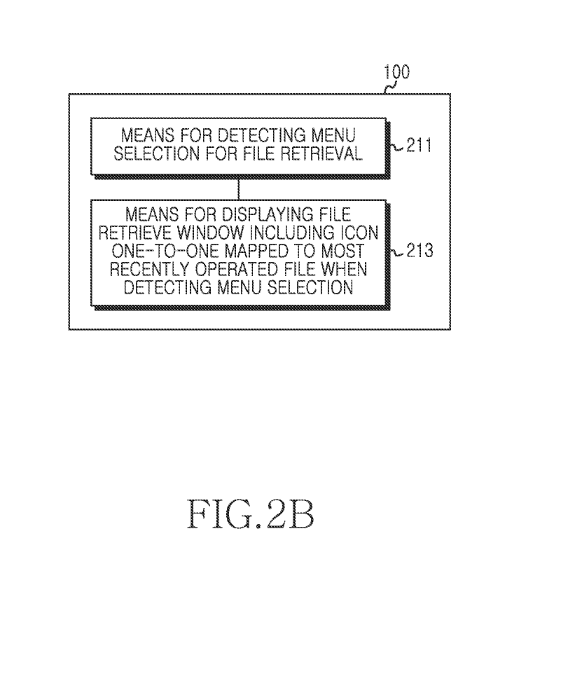

FIG. 2A illustrates a procedure for displaying an icon mapped to a most recently operated file on a file retrieve window in an electronic device 100 according to an embodiment of the present.

Referring to FIG. 2A, the electronic device 100 detects menu selection for file retrieval at operation 201. For example, the electronic device 100 may detect menu selection for attaching an image file in a document editor. For another example, the electronic device 100 may detect menu selection for loading a document file in a document editor.

After that, the electronic device 100 proceeds to operation 203 to display a file retrieve window including an icon one-to-one mapped to a most recently operated file when the menu selection is detected. At this point, the most recently operated file includes at least one of a most recently accessed file and a most recently stored file. For example, the electronic device 100 may display an icon mapped to a most recently accessed file on a file retrieve window. At this point, in the case where selection of a displayed icon is detected, the electronic device 100 may select the most recently accessed file mapped to the relevant icon. For another example, the electronic device 100 may display an icon mapped to a most recently stored file on the file retrieve window. At this point, in the case where selection of a displayed icon is detected, the electronic device 100 may select the most recently stored file mapped to the relevant icon.

The electronic device 100 according to the present disclosure may display both an icon mapped to a most recently accessed file and an icon mapped to a most recently stored file on the file retrieve window, and display only one icon of the two icons when needed.

FIG. 2B illustrates means for displaying an icon mapped to a most recently operated file on a file retrieve window in an electronic device according to an embodiment of the present disclosure.

Referring to FIG. 2B, the electronic device 100 includes means 211 for detecting menu selection for file retrieval. For example, in the case where the electronic device 100 is a computer, the means 211 for detecting menu selection for file retrieval may be means for detecting a click of the menu. For another example, in the case where the electronic device 100 is a device having a touchscreen, the means 211 for detecting menu selection for file retrieval may be means for detecting a touch of the menu.

Also, the electronic device 100 includes means 213 for displaying a file retrieve window including an icon one-to-one mapped to a most recently operated file when detecting menu selection. In other words, the electronic device 100 includes means for displaying an icon mapped to a most recently accessed file and an icon mapped to a most recently stored file on the file retrieve window. At this point, the icon mapped to the most recently accessed file and the icon mapped to the most recently stored file may be discriminated and displayed as separate icons.

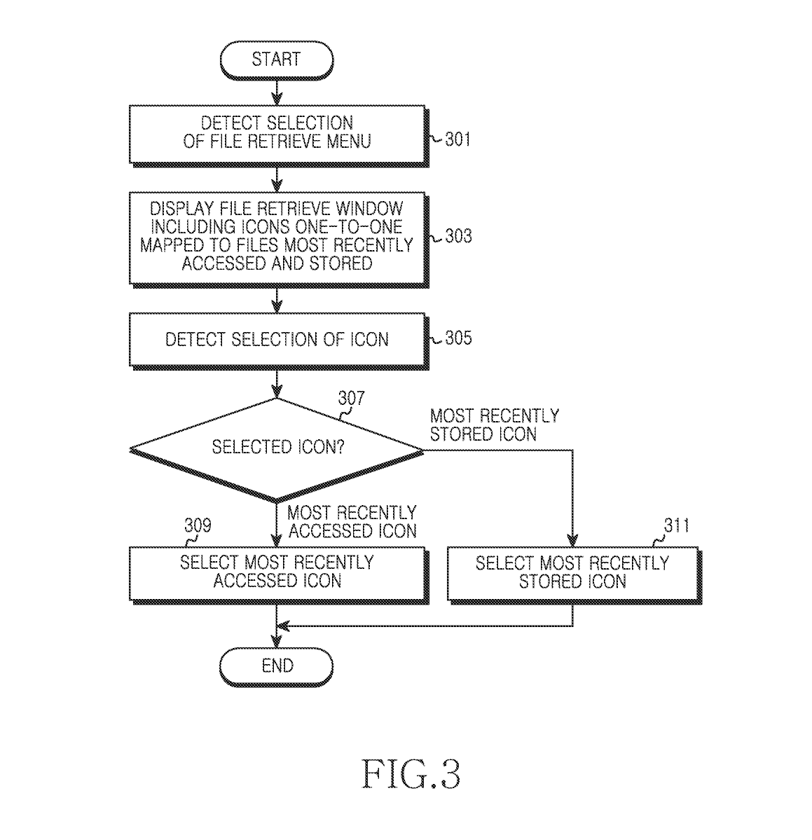

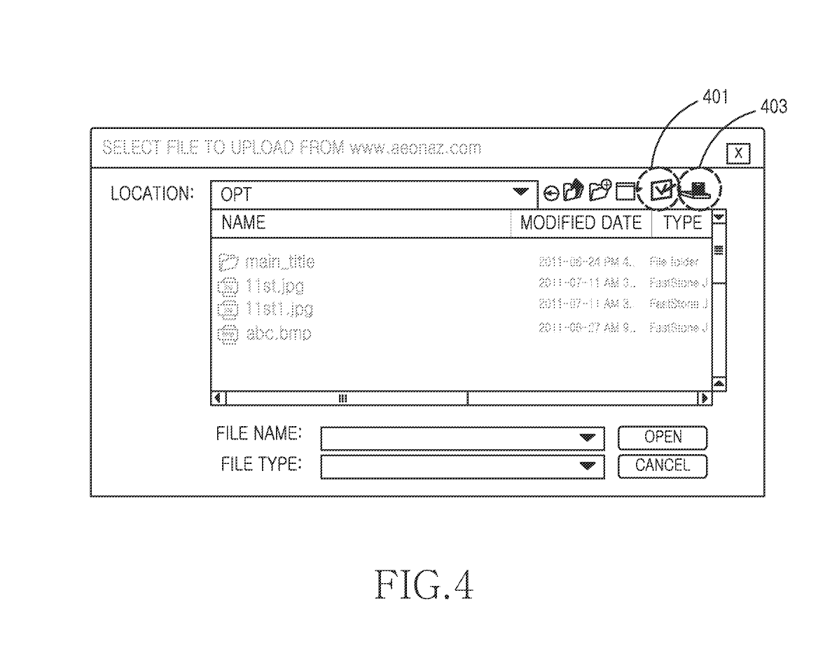

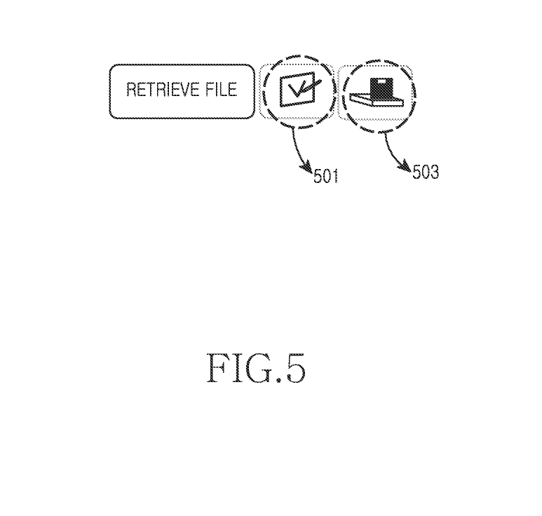

FIG. 3 illustrates a procedure for displaying an icon mapped to a most recently operated file on a file retrieve window in an electronic device according to an embodiment of the present disclosure. FIG. 4 is a view illustrating an example of displaying an icon mapped to a most recently operated file on a file retrieve window in an electronic device according to another embodiment of the present disclosure. FIG. 5 is a view illustrating an example of displaying a quick menu window for a folder in an adjacent region of the folder in an electronic device according to an embodiment of the present disclosure.

Referring to FIG. 3, the electronic device 100 may detect menu selection for file retrieval at operation 301. At this point, the file retrieval includes file retrieval for attaching a file and file retrieval for loading a file. For example, the electronic device may detect menu selection for attaching a file. For another example, the electronic device may detect menu selection for loading a file.

After that, the electronic device 100 may proceed to operation 303 to display a file retrieve window including icons one-to-one mapped to a most recently accessed file and a most recently stored file. In detail, in the case where menu selection for file retrieval is detected, the electronic device 100 displays an icon for selecting a most recently accessed file and an icon for selecting a most recently stored file on the file retrieve window. For example, as illustrated in FIG. 4, the electronic device 100 may display an icon 401 for selecting a most recently accessed file and an icon 403 for selecting a most recently stored file on an arbitrary region of the file retrieve window.

After that, the electronic device 100 detects selection of an icon displayed on the file retrieve window at operation 305. For example, in the case where the electronic device 100 is a computer, the electronic device 100 may detect a click of an icon displayed on the file retrieve window. For another example, in the case where the electronic device 100 is an electronic device 100 having a touchscreen, the electronic device 100 may detect a touch of an icon displayed on the file retrieve window.

After that, the electronic device 100 proceeds to operation 307 to determine whether the selected icon is an icon mapped to a most recently accessed file or an icon mapped to a most recently stored file.

In the case where the selected icon is an icon mapped to a most recently accessed file, the electronic device 100 proceeds to operation 309 to select the most recently accessed file and ends the procedure according to the embodiment of the present disclosure. For example, in the case where selection of an icon mapped to a most recently accessed file is detected, the electronic device 100 may attach or load the most recently accessed file mapped to the relevant icon without an additional process for retrieving or selecting the file.

In contrast, in the case where the selected icon is an icon mapped to a most recently stored file, the electronic device 100 proceeds to operation 311 to select the most recently stored file and then ends the procedure according to the embodiment of the present disclosure. For example, in the case where selection of an icon mapped to a most recently stored file is detected in the file retrieve window, the electronic device 100 may attach or load the most recently stored file mapped to the relevant icon without an additional process for retrieving or selecting the file.

The electronic device 100 according to the present disclosure may display icons one-to-one mapped to a most recently accessed file and a most recently stored file on a quick execute tool box window of a relevant program or an application besides the file retrieve window depending on a design scheme. In the case where icons one-to-one mapped to a most recently accessed file and a most recently stored file are displayed on a quick execute tool box window of a specific program, the electronic device 100 may immediately attach or load the file mapped to the relevant icon by detecting selection of the relevant icon without a process of detecting selection of the file retrieve menu. For example, as illustrated in FIG. 5, the electronic device 100 may display an icon 501 mapped to a most recently accessed file and an icon 503 mapped to a most recently stored file on a quick execute tool box.

An embodiment and all functional operations of the disclosure described in the present specification may be implemented using computer software including a structure disclosed in the present specification and equivalents thereof, firmware, or hardware, or a combination of one or more of these. Also, embodiments of the disclosure described in the present specification may be implemented by one or more computer program products, that is, a data processing device, or one or more modules of computer program instructions encoded on a non-transitory computer readable medium for controlling the operation of this device.

The non-transitory computer readable medium may be a machine readable storage medium, a machine readable storage substrate, a memory device, configuration of a material influencing a machine readable radio wave stream, or a combination of one or more of these. A terminology of the data processing device includes a programmable processor, a computer, or all apparatus, devices, and machines for processing data including a multi-processor or computer, for example. The apparatus may include a code for generating an execution environment for a relevant computer program in addition to the hardware, for example, a processor firmware, a protocol stack, a database management system, an operating system or a code forming a combination of one or more of these.

While the disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
detecting menu selection for retrieving a file; and
upon the detecting of the menu selection, displaying a file retrieve window comprising at least one icon one-to-one mapped to a most recently operated file.

2. The method of claim 1, wherein the most recently operated file comprises at least one of a most recently accessed file and a most recently stored file.

3. The method of claim 1, wherein the detecting of the menu selection for the retrieving of the file comprises detecting selection of one of a file attach menu and a file load menu.

4. The method of claim 1, further comprising:
upon detecting selection of the icon displayed on the file retrieve window, selecting a most recently accessed file in the electronic device.

5. The method of claim 1, further comprising:
upon detecting selection of the icon displayed on the file retrieve window, selecting a most recently stored file in the electronic device.

6. The method of claim 1, wherein the displaying of the file retrieve window comprising the at least one icon one-to-one mapped to the most recently operated file comprises:
determining, at the electronic device, the most recently operated file;
one-to-one mapping the determined file to the icon; and
displaying the file retrieve window comprising the icon one-to-one mapped to the determined file.

7. The method of claim 1, further comprising:
upon detecting selection of the icon displayed on the file retrieve window, attaching the file mapped to the icon to a program being executed.

8. The method of claim 1, further comprising:
upon detecting selection of the icon displayed on the file retrieve window, executing the file mapped to the icon using a program being executed.

9. A non-transitory computer readable storage medium storing one or more programs comprising instructions for, when executed by an electronic device, allowing the electronic device to perform the method of claim 1.

10. An electronic device for retrieving a file, the electronic device comprising:
one or more processors;
an Input/Output (I/O) unit;
a memory; and
one or more programs stored in the memory and configured for execution by the one or more processors,
wherein the one or more programs comprise an instruction for detecting menu selection for retrieving a file, and upon the detecting of the menu selection, for displaying a file retrieve window comprising at least one icon one-to-one mapped to a most recently operated file.

11. The electronic device of claim 10, wherein the most recently operated file comprises at least one of a most recently accessed file and a most recently stored file.

12. The electronic device of claim 10, wherein the one or more programs comprise an instruction for detecting selection of one of a file attach menu and a file load menu in order to retrieve the file.

13. The electronic device of claim 10, wherein the one or more programs further comprise an instruction for selecting a most recently accessed file in the electronic device upon selection of the icon displayed on the file retrieve window being detected.

14. The electronic device of claim 10, wherein the one or more programs further comprise an instruction for selecting a most recently stored file in the electronic device upon selection of the icon displayed on the file retrieve window being detected.

15. The electronic device of claim 10, wherein the one or more programs further comprise an instruction for determining the most recently operated file in the electronic device, for one-to-one mapping the determined file to the icon, and for displaying the file retrieve window comprising the icon one-to-one mapped to the determined file.

16. The electronic device of claim 10, wherein the one or more programs further comprise an instruction for attaching the file mapped to the icon to a program being executed upon selection of the icon displayed on the file retrieve window being detected.

17. The electronic device of claim 10, wherein the one or more programs further comprise an instruction for executing the file mapped to the icon using a program being executed upon selection of the icon displayed on the file retrieve window being detected.
